(19) United States
(12) Patent Application Publication
(10) Pub. No.: US 2014/0300691 A1
(43) Pub. Date: Oct. 9, 2014

(54) IMAGING SYSTEM

(71) Applicant: Panasonic Corporation, Osaka (JP)

(72) Inventors: Hiroshi SAITO, Osaka (JP); Hideaki KOBAYASHI, Hyogo (JP); Masashi FUKATANI, Nara (JP)

(21) Appl. No.: 14/199,203

(22) Filed: Mar. 6, 2014

(30) Foreign Application Priority Data
Apr. 4, 2013 (JP) 2013-078294

(51) Int. Cl. H04N 5/232

(52) U.S. Cl. CPC H04N 5/23238
USPC 348/38

(57) ABSTRACT

An imaging system is an imaging system for shooting a plurality of images to generate a panoramic image. The imaging system includes a plurality of cameras. Each camera has each of a plurality of sub-regions of a subject region as a shooting region, the sub-regions resulting from dividing the subject region in a first direction. Each camera is arranged adjacent to an other camera in either the first direction or a second direction orthogonal to the first direction, the other camera handling a shooting region adjacent to a shooting region handled by each camera. The number of the pairs of cameras adjacent to each other in the first direction is less than the number of the pairs of cameras adjacent to each other in the second direction.

### BACKGROUND

1. Technical Field

The present disclosure relates to an imaging system capable of capturing a panoramic image.

2. Related Art

There has been known an art of generating panoramic image data by synthesizing pieces of captured image data. For example, JP 2011-199425 A discloses an art of generating panoramic image data by capturing images with a horizontally rotated single digital camera and then making the captured two pieces of image data which are sequential in a time series overlap each other. JP 2011-4340 A discloses an art of generating a panoramic image by shooting images with both imaging units of a stereo camera and then synthesizing both of the shot images.

### SUMMARY

Both arts of shooting a plurality of images with a rotated digital camera and shooting images with a stereo camera cause parallax between a plurality of shot images because each of the images is shot in different orientation. When parallax between the shot images is large, a panorama synthesis process is disturbed, thus, generation of preferable panorama image data might be prevented.

The present disclosure is made in view of the aforementioned problem and provides a camera system which reduces an influence of parallax between a plurality of shot images.

The imaging system according to the present disclosure is an imaging system for shooting a plurality of images to generate a panoramic image. The imaging system includes a plurality of cameras. Each camera has each of a plurality of sub-regions of a subject region as a shooting region, the sub-regions resulting from dividing the subject region in a first direction. Each camera is arranged adjacent to an other camera in either the first direction or a second direction orthogonal to the first direction, the other camera handling a shooting region adjacent to a shooting region handled by each camera. The number of the pairs of cameras adjacent to each other in the first direction is less than the number of the pairs of cameras adjacent to each other in the second direction.

The present disclosure can provide an imaging apparatus and an imaging system which reduce an influence of parallax between a plurality of shot images.

### BRIEF DESCRIPTION OF DRAWINGS

FIG. 1 is a diagram illustrating an overview of a panorama image processing system;

FIG. 2 is a diagram illustrating a configuration of a digital camera;

FIG. 3 is a diagram illustrating shooting regions handled by respective digital cameras;

FIG. 4 is a diagram illustrating a configuration of an image processing apparatus;

FIG. 5 is a diagram illustrating a configuration of a projector;

FIG. 6A is a diagram illustrating an arrangement of digital cameras in a camera system, FIG. 6B is a diagram illustrating an arrangement of digital cameras in a camera system of a comparative example, and FIG. 6C is a diagram illustrating an aspect in which a subject region is divided into a plurality of shooting regions;

FIGS. 7A to 7C are diagrams illustrating other examples of arrangement of digital cameras in the camera system; and

FIG. 8A is a diagram illustrating another configuration example of the camera system, and FIG. 8B is a diagram illustrating shooting regions resulting from dividing the subject region, according to a camera system in the other configuration example.

### DETAILED DESCRIPTION OF PREFERRED EMBODIMENTS

Embodiments will be described in detail below with reference to the drawings as required. However, unnecessarily detailed description may be omitted. For example, detailed description of already known matters and overlapping description of substantially the same configuration may be omitted. Such omissions are made for avoiding unnecessary redundancy in the following description to facilitate understanding by those skilled in the art.

The inventor(s) provide the attached drawings and the following description for those skilled in the art to fully understand the present disclosure and this does not intend to limit the subject described in the claims.

### First Embodiment

A panorama image processing system 100 according to the first embodiment can generate and provide a panorama composite image based on shot images of a meeting place such as a stadium and an event site. The panorama image processing system 100 according to the first embodiment reduces an influence of parallax between shot images with a devised arrangement of digital cameras 300.

A configuration of the panorama image processing system 100 according to the first embodiment and an arrangement of the digital cameras 300 will be described in detail below.

### 1. Configuration

### 1-1. Overview of Panorama Image Processing System 100

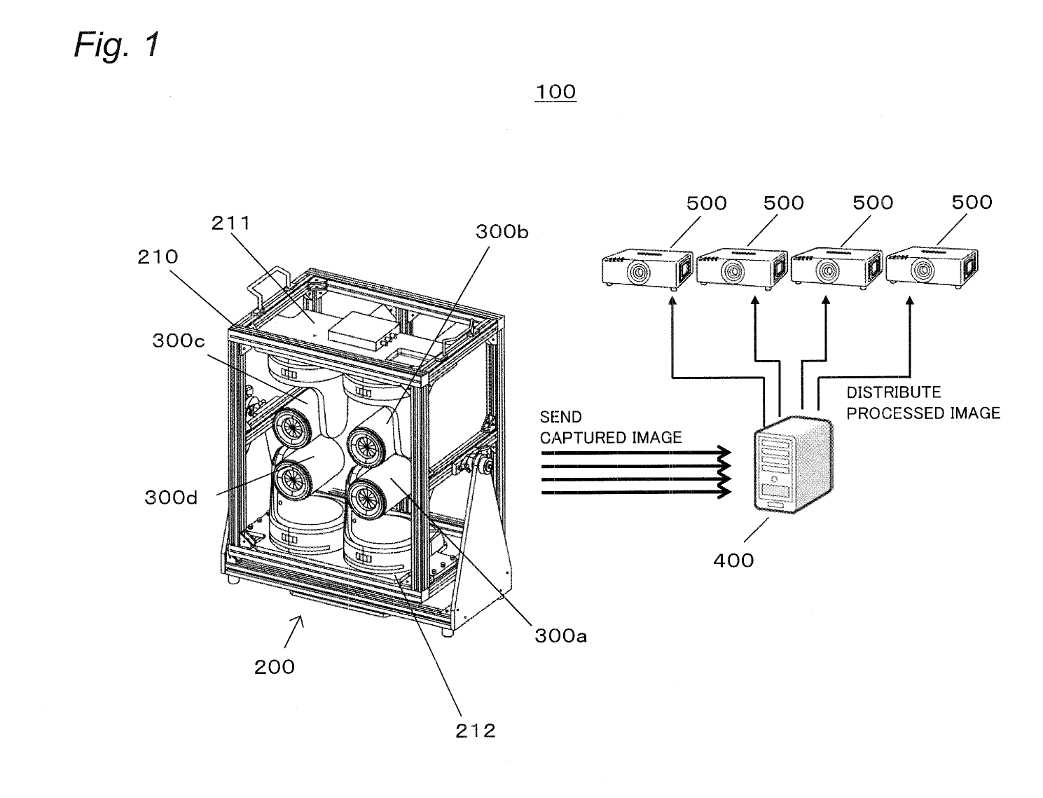

FIG. 1 is a diagram illustrating an overview of the panorama image processing system 100. As illustrated in FIG. 1, the panorama image processing system 100 includes a camera system 200, an image processing apparatus 400, and projectors 500.

The camera system 200 includes a plurality of digital cameras 300a to 300d and is favorable to shooting images of a meeting place relatively long in a horizontal direction such as a stadium and an event site. In the description below, the digital cameras 300a to 300d may be collectively denoted by the reference numeral “300”.

The image processing apparatus 400 receives image data captured by the camera system 200. The image processing apparatus 400 performs a panorama synthesis process on the image data received from the camera system 200 to generate panorama composite image data. The image processing apparatus 400 can record the generated panorama composite image data in a recording medium. Further, the image processing apparatus 400 can output the generated panorama composite image data to the projectors 500.

The projectors 500 can project images based on the image data received from the image processing apparatus 400 on screens. In the present embodiment, four projectors 500 are used. Each of the images projected from the respective projectors 500 is coupled with another one of the images horizontally adjacent to it so that all the images form a panoramic image as a whole. Note that the panoramic image projected from the projectors 500 is based on all or part of the image data captured by the plurality of digital cameras 300.

configurations of the camera system 200, the image processing apparatus 400, and the projector 500 will be described below.

### 1-2. Configuration of Camera System 200

The camera system 200 includes the plurality of digital cameras 300a to 300d. In the example illustrated in FIG. 1, the camera system 200 includes four digital cameras 300a, 300b, 300c, and 300d. As illustrated in FIG. 1, the four digital cameras 300a to 300d are arranged in and fixed to a frame structured frame 210. The frame 210 has a board-shaped frame upper surface 211 and a board-shaped frame lower surface 212. The digital cameras 300a and 300d are arranged side by side on the upper side of the frame lower surface 212. Also, the digital cameras 300b and 300c are arranged side by side on the under side of the frame upper surface 211. In this manner, the plurality of digital cameras 300a to 300d can be compactly arranged in the frame 210.

The four digital cameras 300a to 300d send captured images to the image processing apparatus 400 independently of each other.

### 1-2-1. Configuration of Digital Camera

Next, a configuration of each of the digital cameras 300a to 300d will be described. The four digital cameras 300a to 300d have a common configuration. Accordingly, the description below is applied to all of the four digital cameras 300.

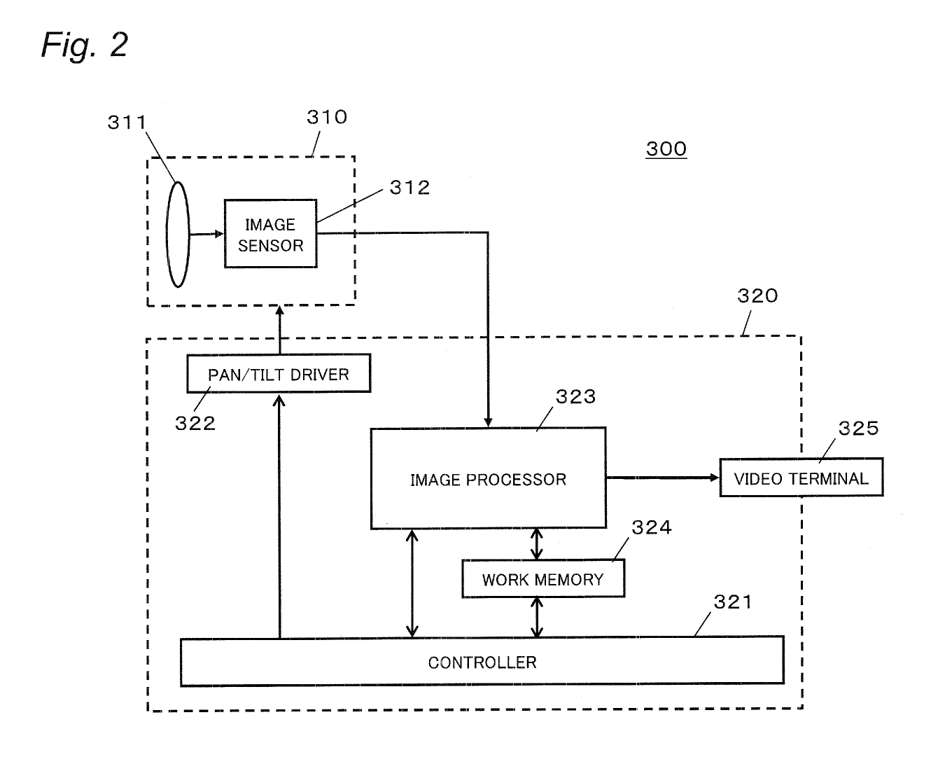

FIG. 2 is a diagram illustrating a configuration of the digital camera 300. The digital camera 300 includes a camera head 310 and a camera base 320.

The camera head 310 has an optical system 311 and an image sensor 312. The camera base 320 includes a controller 321, a pan/tilt driver 322, an image processor 323, a work memory 324, and a video terminal 325. The pan/tilt driver 322 drives the camera head 310 to pan or tilt the camera head 310. This enables to change or adjust an image shooting orientation of each digital camera 300 of the camera system 200 to be changed or adjusted.

The optical system 311 includes a focus lens, a zoom lens, a diaphragm, a shutter, and the like. The optical system 311 may also include an optical camera shake correcting lens (optical image stabilizer (OIS)). Note that the respective lens of the optical system 311 may be implemented by any number of various types of lenses or any number of various types of lens groups.

The image sensor 312 captures a subject image formed by the optical system 311 to generate captured data. The number of pixels of the image sensor 312 is at least the number of horizontal pixels 1920 [2K]×the number of vertical pixels 1080 [1K]. The image sensor 312 generates captured data of a new frame at a predetermined frame rate (for example, 30 frames/second). The timing of generating the image data and an electronic shutter operation of the image sensor 312 are controlled by the controller 321. The image sensor 312 sends the generated captured data to the image processor 323.

The image processor 323 performs various types of processing on the captured data received from the image sensor 312 to generate image data. At this time, the image processor 323 generates full Hi-Vision (the number of horizontal pixels 1920 [2K]×the number of vertical pixels 1080 [1K]) image data. The various types of processing include, but not limited to, white balance correction, gamma correction, YC conversion process, and electronic zoom process. The image processor 323 may be implemented by a hardwired electronic circuit, a microcomputer using programs, or the like. The image processor 323 may be implemented into a single semiconductor chip together with the controller 321 and the like.

The controller 321 performs integrated control on the respective units of the digital camera 100 such as the image processor 323 and the pan/tilt driver 322. The controller 321 may be implemented by a hardwired electronic circuit, a microcomputer using programs, or the like. Further, the controller 321 may be implemented into a semiconductor chip together with the image processor 323 and the like.

The pan/tilt driver 322 is a driving unit for panning or tilting the orientation of the camera head 310 to shoot an image. The pan/tilt driver 322 drives the camera head 310 to pan or tilt based on the instruction from the controller 321. For example, the pan/tilt driver 322 can drive the camera head 310 to pan by ±175 degrees and to tilt from −30 degrees to +210 degrees. The pan/tilt driver 322 may be implemented by a pan driver and a tilt driver independent of each other.

The work memory 324 is a storage medium that functions as a work memory for the image processor 323 or the controller 321. The work memory 324 may be implemented by a DRAM (Dynamic Random Access Memory) or the like.

The video terminal 325 is a terminal for outputting the image data generated by the image processor 323 to the outside of the digital camera 300. The video terminal 325 may be implemented by an SDI (Serial Digital Interface) terminal or an HDMI (High-Definition Multimedia Interface) terminal. The image data output from the video terminal 325 of each of the digital cameras 300 is input into a video terminal 402 of the image processing apparatus 400.

The controller 321 outputs an identifier for identifying the digital camera 300 together with the captured image data when outputting the image data to the image processing apparatus 400. For example, captured image data output from the digital camera 300a is sent to the image processing apparatus 400 together with the identifier for identifying the digital camera 300a. The image processing apparatus 400 can recognize which of the digital cameras 300 generates the obtained captured image data by referring to the identifier.

Although the four digital cameras 300a, 300b, 300c, and 300d have a common configuration in the above description, the idea of the present embodiment is not limited to that and the four digital cameras 300 may have different configurations. However, when the four digital cameras 300 have a common configuration, the integrated control is simple.

### 1-2-2. Shooting Regions Handled by Digital Cameras 300

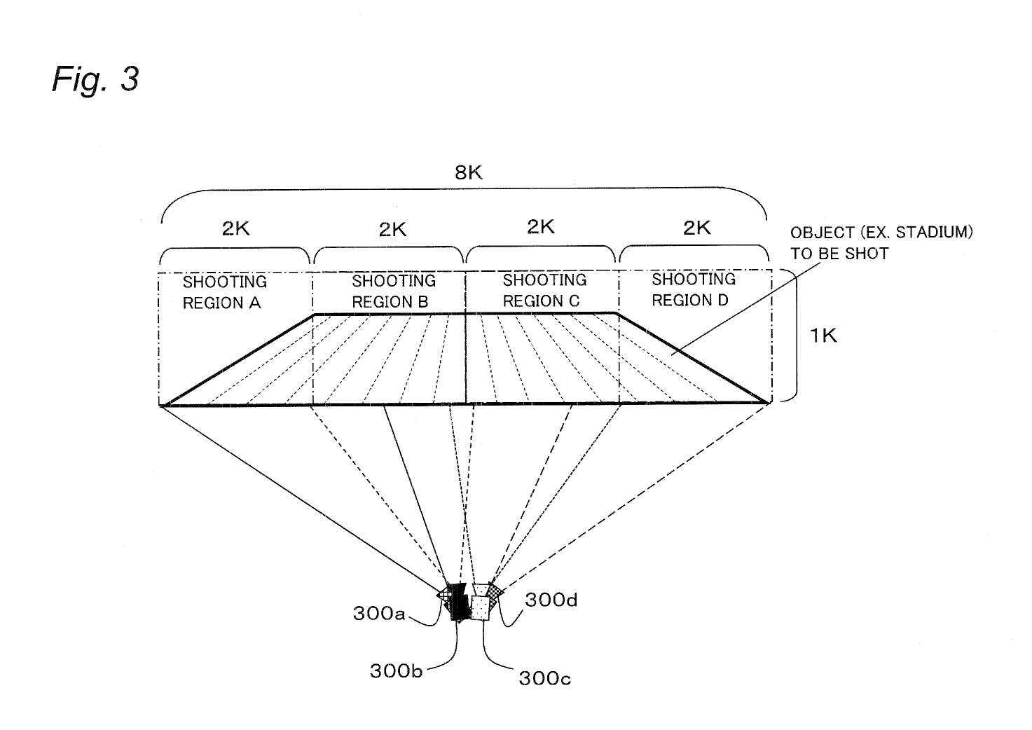

Now, the shooting regions handled by the four digital cameras 300a, 300b, 300c, and 300d in generation of a panorama composite image will be described. FIG. 3 is a diagram describing the shooting regions handled by the respective digital cameras 300a to 300d.

The camera system 200 shoots an image of a subject relatively long in a horizontal direction (for example, a stadium) by using the four digital cameras 300a to 300d. As illustrated in FIG. 3, the camera system 200 shoots an image of a subject (object to be shot) with the region of the subject horizontally dividing into four shooting regions. In the embodiment, the shooting region containing the whole object to be shot (for example, a stadium) is horizontally divided into four regions of a shooting region A, a shooting region B, a shooting region C, and a shooting region D.

The four shooting regions resulting from the dividing are handled by the respective four digital cameras 300a to 300d. That is, as illustrated in FIG. 3, the digital camera 300a handles a shooting of the shooting region A; the digital camera 300b handles a shooting of the shooting region B; the digital camera 300c handles a shooting of the shooting region C; and the digital camera 300d handles a shooting of the shooting region D.

A single digital camera can shoot an image with the number of horizontal pixels 1920 [2K]×the number of vertical pixels 1080 [1K], therefore, by synthesizing the images shot by the four digital cameras 300, the camera system 200 can obtain an image with the number of horizontal pixels 7680 [8K]×the number of vertical pixels 1080 [1K]. That is, the camera system 200 can obtain an image of a horizontally wide subject (a stadium or the like) as high-resolution as 8K.

The panorama image processing system 100 according to the present embodiment reduces an influence of parallax between shot images with a devised arrangement of digital cameras 300. The arrangement of the digital cameras 300 will be detailed later.

### 1-3. Configuration of Image Processing Apparatus 400

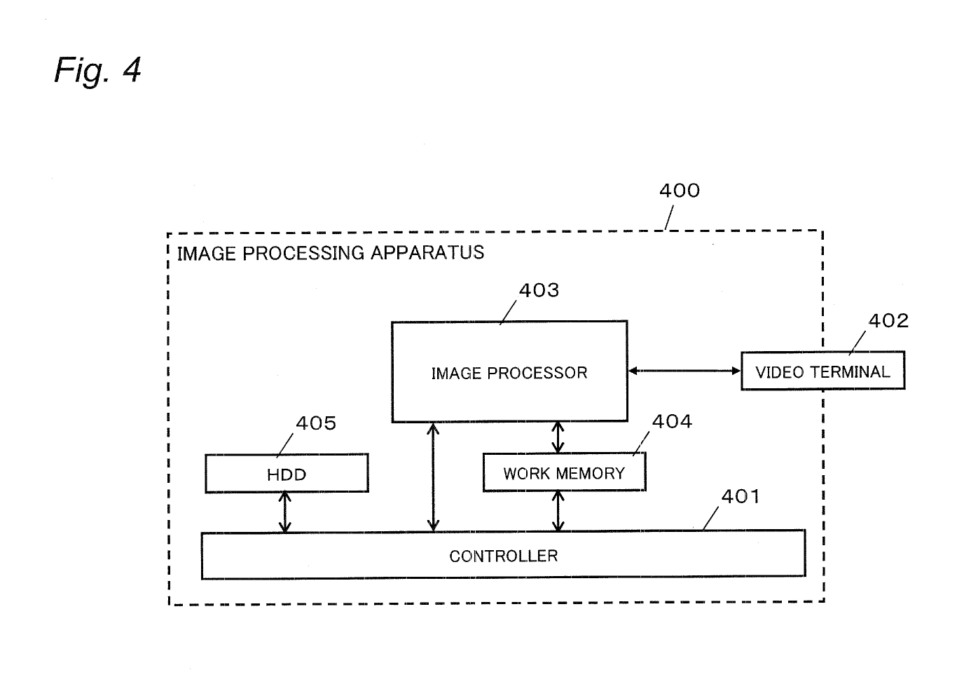

FIG. 4 is a diagram illustrating a configuration of the image processing apparatus 400. The image processing apparatus 400 is implemented by a personal computer for example and has a controller 401, a video terminal 402, an image processor 403, a work memory 404, and a hard disk drive (hereinafter, referred to as “EDD”) 405.

The controller 401 performs integrated control on operations of the respective units of the image processing apparatus 400 such as the image processor 403 and the HDD 405. The controller 401 may be implemented by a hardwired electronic circuit, a microcomputer executing programs, or the like. Further, the controller 401 may be implemented into a semiconductor chip together with the image processor 403 and the like.

The video terminal 402 is a terminal for inputting image data from the outside of the image processing apparatus 400 and outputting image data generated by the image processor 403 to the outside of the image processing apparatus 400. The video terminal 402 may be implemented by an SDI terminal or an HDMI terminal. When an SDI terminal is adopted as the video terminal 325 of the digital camera 300, an SDI terminal is adopted as the video terminal 402 of the image processing apparatus 400.

The image processor 403 performs various types of processing on the image data input from the outside of the image processing apparatus 400 to generate panorama composite image data. The image processor 403 generates panorama composite image data of the number of horizontal pixels 7680 [8K]×the number of vertical pixels 1080 [1K]. On that occasion, by using the identifiers received from the digital cameras 300 together with the captured image data, the image processor 403 can perform a panorama synthesis process suitable for the arrangement of the shooting regions handled by the respective digital cameras 300 The various types of processing include, but not limited to, panorama synthesis processes such as affine transformation and alignment of feature points, as well as an electronic zoom process and the like. The image processor 403 may be implemented by a hardwired electronic circuit, a microcomputer using programs, or the like. The image processor 403 may be implemented into a single semiconductor chip together with the controller 401 and the like.

The work memory 404 is a storage medium that functions as a work memory for the image processor 403 or the controller 401. The work memory 324 may be implemented by a DRAM (Dynamic Random Access Memory) or the like.

The HDD 405 is an auxiliary recording device to which information such as image data is written and from which such information is read. The HDD 405 can record the panorama composite image data generated by the image processor 403 according to the instruction from the controller 401. The HDD 405 allows the recorded panorama composite image data to be read out from the HDD 405 according to the instruction from the controller 401. The panorama composite image data read out from the HDD 405 may be copied to or moved to an external recording device such as a memory card or may be displayed on a display device such as a liquid crystal display.

### 1-4. Configuration of Projector 500

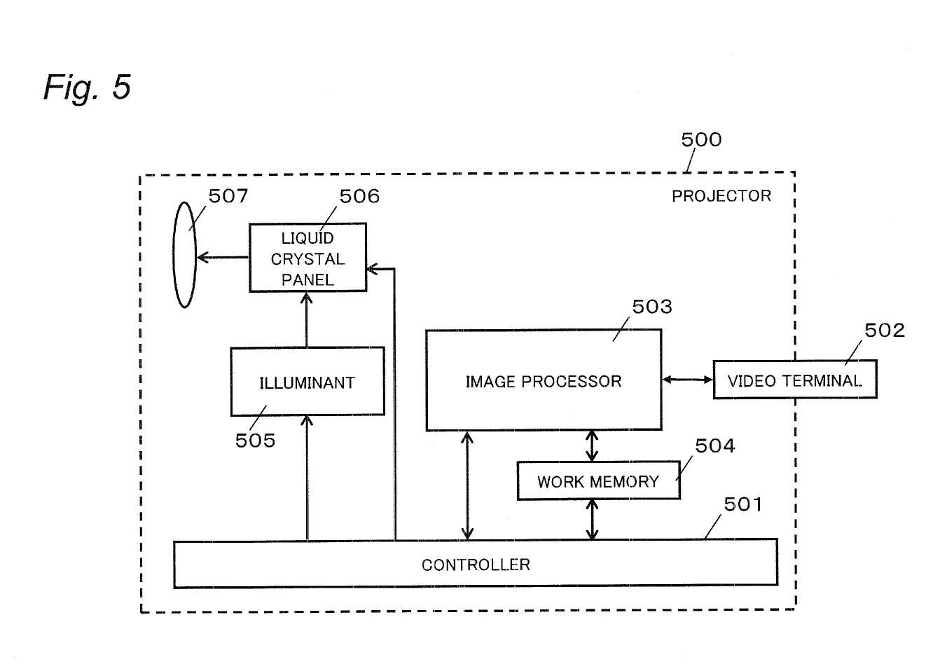

FIG. 5 is a diagram illustrating a configuration of the projector 500. The projector 500 has a controller 501, a video terminal 502, an image processor 503, a work memory 504, an illuminant 505, a liquid crystal panel 506, and an optical system 507.

The controller 501 performs integrated control on the respective units of the projector 500 such as the image processor 503, the illuminant 505, and the liquid crystal panel 506. The controller 501 may be implemented by a hardwired electronic circuit, a microcomputer executing programs, or the like. Further, the controller 501 may be implemented into a semiconductor chip together with the image processor 503 and the like.

The video terminal 502 is a terminal for inputting the image data from the outside of the projector 500. From the video terminal 502, the panorama composite image generated by the image processor 400 is input. As illustrated in FIG. 1, when projection is performed by the four projectors, each of the projectors may be adapted to receive image data of only an image region to be projected by each projector out of the panorama composite image data generated by the image processor 400. The video terminal 402 may be implemented by an SDI terminal or an HDMI terminal. When SDI terminals are adopted as the video terminals 402 of the image processing apparatus 400, SDI terminals are adopted as the video terminals 502 of the projectors 500.

The image processor 503 performs respective processes on the image data input from the outside of the projector 500, then sends information about the brightness and the hue of the pixels of the image to the controller 501. The image processor 503 may be implemented by a hardwired electronic circuit, a microcomputer using programs, or the like. The image processor 503 may be implemented into a single semiconductor chip together with the controller 501 and the like.

The illuminant 505 has a luminous tube and the like. The luminous tube emit luminous flux of red, green, and blue lights each of which has a wavelength region different from each other. The luminous tube may be implemented by, for example, an ultra-high pressure mercury lamp or a metal halide lamp. The luminous flux emitted from the illuminant 505 is projected onto the liquid crystal panel 506. Although not illustrated in FIG. 5, light may be projected from the illuminant 505 onto the liquid crystal panel 506 through an optical system including a condenser lens, a relay lens, and so on.

The liquid crystal panel 506 has color filters of RGB arranged on the liquid crystal panel 506. The liquid crystal panel 506 controls the color filters to reproduce an image based on image data instructed by the controller 501. Although the example illustrated in FIG. 5 uses a transmissive liquid crystal panel, the idea of the present disclosure is not limited to that. That is, the liquid crystal panel may be a reflective liquid crystal panel or a DLP (Digital Light Processing) liquid crystal panel. Further, the liquid crystal panel may be in a single-panel system or a three-panel system.

The optical system 507 includes a focus lens and a zoom lens. The optical system 507 is an optical system for expanding the luminous flux entered through the liquid crystal panel 506.

### 2. Arrangement of Digital Cameras 300 in Camera System 200

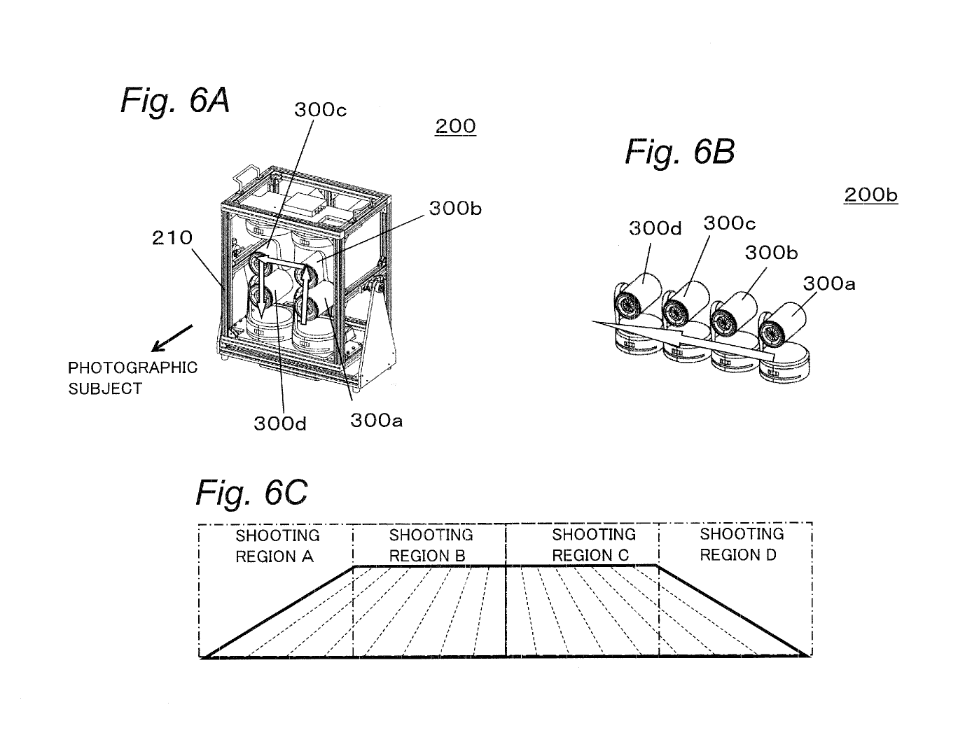

FIGS. 6A to 6C are diagrams for describing an arrangement of digital cameras 300 in the camera system 200.

FIG. 6A is a diagram illustrating an arrangement of digital cameras 300a to 300d according to the first embodiment. FIG. 6B is a diagram illustrating a camera arrangement for a comparison with the camera arrangement illustrated in FIG. 6A. FIG. 6C is a diagram describing the shooting regions handled by the respective digital cameras 300a to 300d as illustrated in FIG. 3.

As illustrated in FIG. 6C, the object to be shot (for example, a stadium) is divided into four shooting regions. Left to right from the viewpoint of the digital cameras, the shooting regions are referred to as the shooting region A, the shooting region B, the shooting region C, and the shooting region D. As described above, the shooting regions A to D are allocated to the respective digital cameras 300a to 300d as illustrated in FIG. 3. In the description below, the direction to the subject of the digital cameras 300 is assumed to be the front of the camera systems 200 and 200b. Therefore, the direction from the digital camera 300a to the digital camera 300d is the “right direction” from the viewpoint of the camera system 200 and the opposite direction is the “left direction”. Also, the direction from the digital camera 300a to the digital camera 300b is the “upward direction” of the camera system 200 and the opposite direction is the “downward direction”. With respect to the camera system 200b of the comparative example, the direction from the digital camera 300a to the digital camera 300d is the “right direction” from the viewpoint of the camera system 200b and the opposite direction is the “left direction”.

As illustrated in FIG. 6A, the digital camera 300a, which is arranged on the left side of the frame 210 of the camera system 200 handles a shooting of the leftmost shooting region A out of the object to be shot (for example, a stadium). The digital camera 300b, which is arranged on the left side of the frame 210 of the camera system 200 and adjacent to the top of the digital camera 300a handles a shooting of the shooting region B adjacent to the shooting region A. The digital camera 300c, which is arranged on the right side of the frame 210 of the camera system 200 and adjacent to the side of the digital camera 300b handles a shooting of the shooting region C adjacent to the right side of the shooting region B. Then, the digital camera 300d, which is arranged on the right side of the frame 210 of the camera system 200 and adjacent to the bottom of the digital camera 300c handles a shooting of the shooting region D adjacent to the right side of the shooting region C. That is, the four digital cameras handling the respective shooting regions A to D provide a downward U-shaped trace as illustrated in FIG. 6A, when traced in the order of these digital cameras. In other words, the digital cameras 300a to 300d handling the respective shooting regions A to D are arranged in a U-shape. In this case, the camera system 200 has the number of the pair of the cameras 300b and 300c adjacent to each other in the lateral direction (1) less than the number of the pairs of the cameras adjacent to each other in the vertical direction (2). This arrangement reduces the degree of parallax caused in the whole camera system 200.

On the other hand, in the comparative example illustrated in FIG. 6B, the digital cameras 300a to 300d are arrayed in a line in the horizontal direction. That is, The digital camera 300a, which is arranged in the leftmost region in the camera system 200b handles the leftmost shooting region A of the subject (a stadium). The digital camera 300b, which is arranged adjacent to the right side of the digital camera 300a handles the shooting region B adjacent to the right side of the shooting region A. The digital camera 300c, which is arranged adjacent to the right side of the digital camera 300b handles the shooting region C adjacent to the right side of the shooting region B. The digital camera 300d, which is arranged adjacent to the right side of the digital camera 300c handles the shooting region D adjacent to the right side of the shooting region C.

Now, the technical meaning of the camera arrangement illustrated in FIG. 6A will be described.

When two or more digital cameras are arranged in the horizontal direction shifted from each other, the cameras are arranged at a certain distance from each other. As a result, parallax in the horizontal direction occurs between the images shot by these digital cameras. When a wide panorama composite image is generated as a result of stitching of a plurality of shot images in the horizontal direction, joints between the images do not appear seamless under the influence of parallax between the shot images. Therefore, during generation of a panorama composite image, the influence of parallax between the shot images of the shooting regions adjacent to each other needs to be reduced.

For example, when the four digital cameras 300a to 300d are arrayed in a line in the horizontal direction as illustrated in FIG. 6B, a certain amount of parallax (d) always occurs between a digital camera and another digital camera which handles a shooting region adjacent to a shooting region handled by the former digital camera, according to the horizontal distance between these adjacent digital cameras. That is, a certain amount of parallax (d) occurs between the images shot by the digital camera 300a and the digital camera 300b, between the images shot by the digital camera 300b and the digital camera 300c, and between the images shot by the digital camera 300c and the digital camera 300d, respectively. Further, parallax twice as much as the certain amount of parallax (d) occurs between the images shot by the digital camera 300a and the digital camera 300c and between the images shot by the digital camera 300b and the digital camera 300d, respectively. Still further, parallax (3d) three times as much as the amount of parallax (d) between the adjacent cameras occurs between the digital camera 300a and the digital camera 300d which are placed at the both ends. As described above, parallax varies between the cameras and may be larger in some cases. As a result, the parallax negatively affects the panorama composite image, and thus deteriorates the quality of the panorama composite image.

On the other hand, in the camera system 200 according to the first embodiment, the digital cameras 300a to 300d handling the respective continuous shooting regions A to D are arranged in order in a downward U-shape as illustrated in FIG. 6A. In the arrangement in a U-shape, the parallax in the horizontal direction between the shot images does not occur between the digital cameras vertically adjacent to each other (between the digital camera 300a and the digital camera 300b, and between the digital camera 300c and the digital camera 300d). Between the cameras arranged at different positions in the horizontal direction (for example, between the digital camera 300a and the digital camera 300d and between the digital camera 300b and the digital camera 300c), the parallax occurs but just as small as that of the value for one camera (d). Therefore, in the camera arrangement of FIG. 6A, the parallaxes between the four digital cameras 300a to 300d are almost equal, and thus an influence of the parallax on the panorama composite image is reduced. That is, deterioration of the image quality due to the parallax in the horizontal direction can be reduced in the panorama composite image.

As described above, with the camera system 200 according to the first embodiment, the influence of the horizontal parallax between a plurality of shot images can be reduced. Further, with the four digital cameras 300a to 300d arranged in a matrix (in this example, two cameras in the vertical direction×two cameras in the horizontal direction), the whole configuration of the camera system 200 can be made compact.

### Other Embodiments

As described above, the first embodiment has been described as an example of the art disclosed in the present application. However, the art of the present disclosure is not limited to that embodiment and may also be applied to embodiments which are subject to modification, substitution, addition, and/or omission as required. The present disclosure is not limited to the first embodiment and various other embodiments are possible. Other embodiments will be described below.

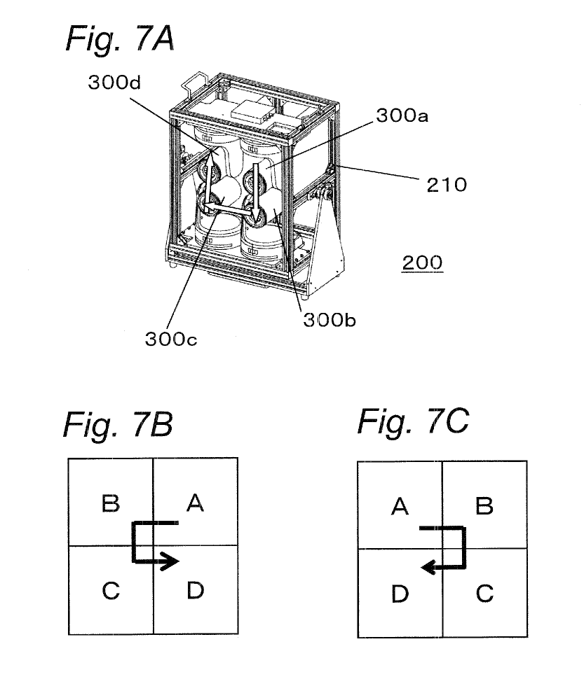

The arrangement of the digital cameras 300 in the camera system 200 is not limited to the example illustrated in FIG. 6A. FIGS. 7A to 7C illustrate other arrangement examples of the digital cameras 300 in the camera system 200.

In this example, shooting region is assumed to be the same as the region containing the shooting region A, the shooting region B, the shooting region C, and the shooting region D illustrated in FIG. 6C. The arrangement of cameras illustrated in FIG. 7A has a corresponding relationship between the digital cameras and the shooting regions different from the arrangement illustrated in FIG. 6A. That is, in the example illustrated in FIG. 7A, the digital cameras 300a to 300d handling the respective shooting regions A to D are arranged in order in an upward U-shape, in the frame 210 of the camera system 200. Specifically, as illustrated in FIG. 7A, the digital camera 300a, which is arranged in the upper left in the frame 210 of the camera system 200 handles the leftmost shooting region A of the region containing the subject (for example, a stadium). The digital camera 300b, which is arranged adjacent to the bottom of the digital camera 300a handles the shooting region B adjacent to the right side of the shooting region A. The digital camera 300c, which is arranged adjacent to the right side of the digital camera 300b handles the shooting region C adjacent to the right side of the shooting region B. The digital camera 300d, which is arranged adjacent to the top of the digital camera 300c handles the shooting region D adjacent to the right side of the shooting region C. In this manner, as illustrated in FIG. 7A, the digital cameras 300 handling the respective shooting regions A to D may be arranged in order in an upward U-shape. In this case, the camera system 200 has the number of the pair of the cameras 300a and 300d adjacent to each other in the lateral direction (1) less than the number of the pairs of cameras adjacent to each other in the vertical direction (2). This arrangement reduces the degree of parallax caused in the whole camera system 200.

When the four digital cameras 300a to 300d handling the respective shooting regions A to D are arranged in the camera system 200, the cameras may be arranged in a downward U-shape as illustrated in FIG. 6A or in an upward U-shape as illustrated in FIG. 7A. Further, as illustrated in FIGS. 7B and 7C, the digital cameras 300 handling the shooting regions A, B, . . . may be arranged in a right or left U-shape. In any one of these cases, the camera system 200 can reduce an influence of the parallax between the plurality of shot images. Further, with the four digital cameras 300 arranged in a matrix (two cameras in the vertical direction×two cameras in the horizontal direction), the configuration of the camera system 200 can be made compact.

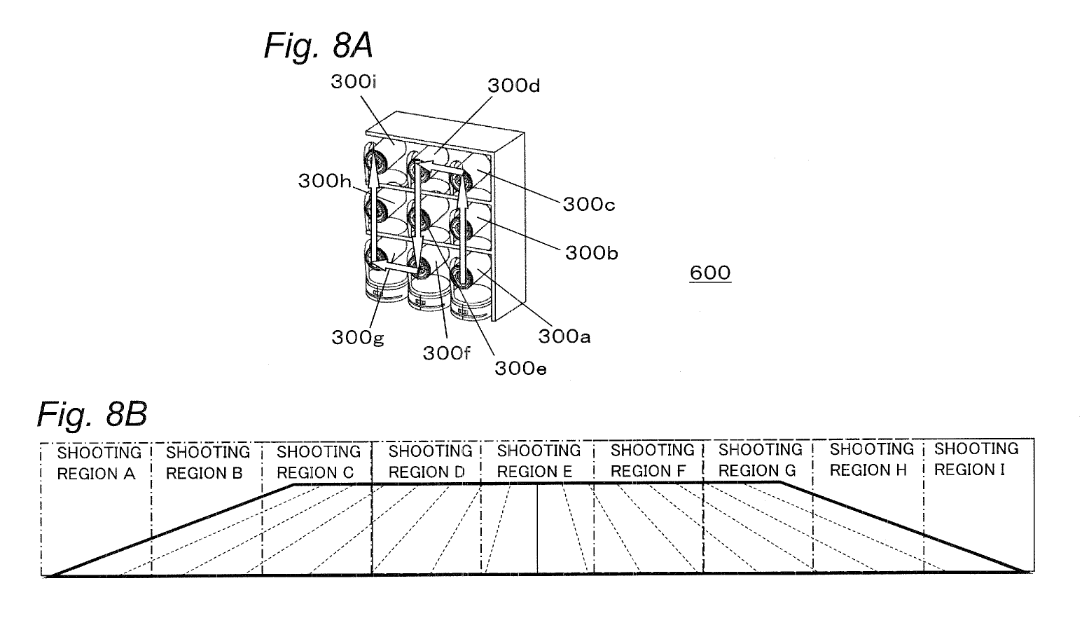

The number of digital cameras arranged in the camera system is not limited to four. For example, as illustrated in FIG. 8A, the camera system 600 may include nine digital cameras 300a to 300i. FIG. 8B illustrates shooting regions handled by the digital cameras 300a to 300i in the camera system 600 configured as illustrated in FIG. 8A.

As illustrated in FIG. 8B, the region of the subject (for example, a stadium) is divided into nine shooting regions. Left to right from the viewpoint of the photographer (the digital cameras 300) toward the subject region, the sub-regions will be referred to as a shooting region A, a shooting region B, a shooting region C, a shooting region D, a shooting region E, a shooting region F, a shooting region G, a shooting region H, and a shooting region I. In this state, as illustrated in FIG. 8A, the leftmost shooting region A of the subject region is allocated to the digital camera 300a which is arranged in the lower left in the frame 210 of the camera system 200. The shooting region B adjacent to the right side of the shooting region A is allocated to the digital camera 300b which is arranged on the left side of the frame 210 of the camera system 200 and adjacent to the top of the digital camera 300a. The shooting region C adjacent to the right side of the shooting region B is allocated to the digital camera 300c which is arranged on the left side of the frame 210 of the camera system 200 and adjacent to the top of the digital camera 300b.

Subsequently, the shooting region D adjacent to the right side of the shooting region C is allocated to the digital camera 300d which is arranged in the center of the frame 210 of the camera system 200 and adjacent to the right side of the digital camera 300c. Similarly, the shooting region E adjacent to the right side of the shooting region D is allocated to the digital camera 300e which is arranged in the center of the frame 210 of the camera system 200 and adjacent to the bottom of the digital camera 300d. Then, the shooting region F adjacent to the right side of the shooting region E is allocated to the digital camera 300f which is arranged in the center of the frame 210 of the camera system 200 and adjacent to the bottom of the digital camera 300e.

Subsequently, the digital camera 300g, which is arranged on the right side of the frame 210 of the camera system 200 and adjacent to the right side of the digital camera 300f, handles the shooting region G adjacent to the right side of the shooting region F. Subsequently, the shooting region H adjacent to the right side of the shooting region G is allocated to the digital camera 300h which is arranged on the right side of the frame 210 of the camera system 200 and adjacent to the top of the digital camera 300g. Then, the shooting region I adjacent to the right side of the shooting region H is allocated to the digital camera 300i, which is arranged on the right side of the frame 210 of the camera system 200 and adjacent to the top of the digital camera 300h. That is, as illustrated in FIG. 8A, the digital cameras 300a to 300i handling the respective nine continuous shooting regions A to I are arranged in the form of S-shape turned on its side in the order of the shooting regions.

In other words, when the respective nine continuous shooting regions A to I are allocated to the respective nine digital cameras 300a to 300i arranged in a matrix of dimension 3×3, the digital cameras 300a to 300i are arranged so that the trace of the cameras has a S-shape turned on its side when the cameras are traced in the order of the shooting regions. In this case, the camera system 200 has the number of the pairs of the cameras (the pairs of the cameras 300f and 300g, 300c and 300d) adjacent to each other in the lateral direction (the direction in which the panorama image is synthesized) (2) less than the number of the pairs of the cameras adjacent to each other in the vertical direction (6). Alternatively, the respective nine continuous shooting regions A to I may be allocated to the respective nine digital cameras arranged in a matrix of dimension 3×3 so that the trace of the cameras has a reversed S-shape when the nine digital cameras 300a to 300i are traced in the order of the shooting regions. By adopting the above described allocation in the arrangement of the nine digital cameras 300, the camera system 200 can reduce an influence of the horizontal parallax between the plurality of shot images. Further, with the nine digital cameras 300 arranged in a matrix (three cameras in the vertical direction×three cameras in the horizontal direction), the configuration of the camera system 200 can be made compact.

Although the above embodiments have been described as examples in which a plurality of digital cameras are arranged in a matrix so that the number of the digital cameras arranged in the vertical direction is the same as the number of the digital cameras arranged in the lateral direction (2×2 and 3×3), the arrangement is not limited to that arrangement. The number of the digital cameras arranged in the vertical direction may differ from the number of the digital cameras arranged in the lateral direction.

The corresponding relationships between the respective digital cameras 300a, 300b, . . . and the respective shooting regions A, B, . . . described in the above embodiments are merely examples. In sum, in the camera system having the plurality of digital cameras arranged in a matrix (m×n), the continuous shooting regions A, B, . . . only need to be allocated to the respective digital cameras so that the trace of the digital cameras handling the shooting regions has a traversable shape when the digital cameras are traced in the order of the shooting regions.

In the above described embodiments, the controllers 321, 401, and 501 may be configured of a CPU (Central Processing Unit), an MPU (Micro Processing Unit), an FPGA (Field Programmable Gate Array), or the like. The image processor 323, 403, and 503 may be configured of a CPU, an MPU, an FPGA, a DSP (Digital Signal Processor), or the like.

### CONCLUSION

As described above, the camera system 200 according to the present embodiment is a camera system for shooting a plurality of images to generate a panoramic image. The camera system 200 includes a plurality of cameras 300a to 300d. Each camera 300a to 300d has each of a plurality of sub-regions of a subject region as a shooting region, the sub-regions resulting from dividing the subject region in a first direction (the direction in which a panorama image is to be synthesized). Each camera 300a to 300d is arranged adjacent to an other camera in either the first direction (lateral direction) or a second direction (vertical direction) orthogonal to the first direction, the other camera handling a shooting region adjacent to a shooting region handled by each camera. In the camera system 200, the number of the pairs of cameras adjacent to each other in the first direction (lateral direction) is less than the number of the pairs of cameras adjacent to each other in the second direction (vertical direction). With that configuration, parallax between the plurality of cameras is equalized and the influence of the parallax on the panorama synthesis process can be reduced.

In the camera system 200, the pair of the cameras adjacent to each other in the first direction (lateral direction) may include two cameras covering the central shooting regions of the subject region. In the panorama synthesis process, the central images of the panorama image are less influenced by the parallax than the images forming the ends of the panorama image. Therefore, the arrangement can reduce the influence of the parallax on the panorama synthesis process.

When the respective sub-regions continuous from one end to the other end of the subject region (for example, the shooting regions A to D) are allocated in order to the cameras 300a to 300d, the cameras 300a to 300d may be arranged so that the trace of the cameras 300a to 300d has a unicursal shape when the cameras 300a to 300d are traced in the order of the regions allocated to the cameras. As a result, the parallax between the adjacent cameras can be reduced.

The embodiments have been described above as examples of the arts of the present disclosure. For that purpose, the accompanying drawings and the detailed description have been provided.

Therefore, the constituent elements illustrated in the accompanying drawings or discussed in the detailed description may include not only the constituent element necessary to solve the problem but also the constituent element unnecessary to solve the problem in order to exemplify the arts. Accordingly, it should not be instantly understood that the unnecessary constituent element is necessary only because the unnecessary constituent element is illustrated in the accompanying drawings or discussed in the detailed description.

Also, the above described embodiments are provided for exemplifying the arts of the present disclosure, and thus various changes, substitutions, additions, omissions, and the like may be performed on the embodiments without departing from the scope of the claims and the equivalent of the scope of the claims.

### INDUSTRIAL APPLICABILITY

The idea of the present disclosure can be applied to a camera system which includes a plurality of cameras.

What is claimed is:

1. An imaging system for shooting a plurality of images to generate a panoramic image, comprising:
a plurality of cameras, wherein
each camera has each of a plurality of sub-regions of a subject region as a shooting region, the sub-regions resulting from dividing the subject region in a first direction,
each camera is arranged adjacent to an other camera in either the first direction or a second direction orthogonal to the first direction, the other camera handling a shooting region adjacent to a shooting region handled by each camera, and
the number of the pairs of cameras adjacent to each other in the first direction is less than the number of the pairs of cameras adjacent to each other in the second direction.

2. The imaging system according to claim 1, wherein each of the pair of cameras adjacent to each other in the first direction includes two cameras handling central shooting regions of the subject region.

3. The imaging system according to claim 1, wherein
when the sub-regions continuously located from one end to the other end of the subject region are allocated in order to the respective cameras,
the plurality of cameras are arranged so that the trace of positions of the cameras has a U-shape when the cameras are traced in the order of allocation of the sub-regions allocated to the cameras.

4. The imaging system according to claim 1, wherein
when the sub-regions continuously located from one end to the other end of the subject region are allocated in order to the respective cameras,
the plurality of cameras are arranged so that the trace of positions of the cameras has a traversable shape when the cameras are traced in the order of allocation of the sub-regions to the cameras.

5. The imaging system according to claim 1, wherein the plurality of cameras include four cameras with two cameras arranged in a lateral direction and two cameras arranged in a vertical direction.

6. The imaging system according to claim 1, wherein the plurality of cameras include nine cameras with three cameras arranged in a lateral direction and three cameras arranged in a vertical direction.
